(19) United States
(12) Patent Application Publication
(10) Pub. No.: US 2020/0304984 A1
(43) Pub. Date: Sep. 24, 2020

(54) Timer Activation for Dual SIM Dual Standby Devices

(71) Applicant: Apple Inc., Cupertino, CA (US)

(72) Inventors: Muthukumaran Dhanapal, Dublin, CA (US); Vijay Venkataraman, Sunnyvale, CA (US); Lakshmi N. Kavuri, San Jose, CA (US); Srinivasan Nimmala, San Jose, CA (US); Rangakrishna Nallandigal, Santa Clara, CA (US); Alosious Pradeep Prabhakar, Singapore (SG); Tsun Sang Cheong, Hong Kong (HK); Rohit R. Matolia, Surat (IN); Yaoqi Yan, Beijing (CN); Chaitanya R. Kaliki, Singapore (SG); Navjot Thakral, Santa Clara, CA (US); Ajinkya Satish Godbole, San Francisco, CA (US)

(21) Appl. No.: 16/362,230

(22) Filed: Mar. 22, 2019

(51) Int. Cl. H04W 8/18; H04W 88/06; H04W 56/00; H04W 76/27; H04W 76/28

(52) U.S. Cl. CPC H04W 8/183; H04W 88/06; H04W 76/28; H04W 76/27; H04W 56/001

(57) ABSTRACT

Apparatuses, systems, and methods for a dual subscriber identity module (SIM) dual standby (DSDS) capable user equipment (UE) devices to perform data operations with a first SIM that is not capable of or preferred for packet switched (PS) services and a second SIM that is capable of or preferred for PS services. A timer may be initiated upon radio frequency (RF) chain handover from the first SIM to the second SIM, whereupon a first connection associated with the first SIM is maintained in an idle state while the timer is running. Upon expiration of the timer, the UE may determine whether to send a scheduling request to maintain or release the first connection. The timer may be utilized when a call is dropped over the first connection, to increase the likelihood of successfully receiving a callback. The timer may be shortened in duration to reduce reception of spam messaging.

### FIELD

The present application relates to wireless devices, including apparatuses, systems, and methods for operating a dual subscriber identity module (SIM) dual standby (DSDS) wireless device.

### DESCRIPTION OF THE RELATED ART

Wireless communication systems are rapidly growing in usage. Further, wireless communication technology has evolved from voice-only communications to also include the transmission of data, such as Internet and multimedia content. In certain scenarios a wireless device may include or be capable of utilizing multiple subscriber identity modules (SIMs). Determining how to operate effectively and efficiently with multi-SIM capability may be a challenging problem. Thus, improvements in the field are desired.

### SUMMARY

Embodiments are presented herein of apparatuses, systems, and methods for a multi-subscriber identity module (multi-SIM) wireless device such as a dual subscriber identity module (SIM) dual standby (DSDS) capable user equipment device (UE) to improve wireless communications using multiple SIMs.

In some embodiments, a DSDS capable UE may establish a first connection with a first network entity using a first SIM, where the first SIM is not capable of (or capable of, but not preferred for) packet switched (PS) services, and the UE may initiate a PS data session with a second network entity using a second SIM, wherein the second SIM is capable of (and/or preferred for) PS services.

In some embodiments, at least in part in response to initiating the PS data session using the second SIM, the UE may initiate a timer, wherein the first connection is maintained in an idle state until the timer expires. Upon expiry of the timer, the UE may check whether the second SIM has finished its PS data sessions and/or if it has handed access to radio frequency (RF) resources back to the first SIM. Based on a determination that the second SIM has finished its PS data sessions and/or if it has handed access to radio frequency (RF) resources back to the first SIM, the UE may send a scheduling request to the first network entity using the first SIM to maintain the first connection. If the second SIM is still conducting the PS data session upon expiry of the timer, the UE may release the first connection.

In some embodiments, the duration of the timer may be dynamically selected based on whether a spam message has been received over the first connection. For example, the timer may be set to a shorter duration so that the first connection is released sooner if the UE receives a spam message over the first connection.

In some embodiments, if a circuit switched call is dropped using the first SIM, the UE may initiate a timer to maintain the first connection for a short period of time, in case a callback is received for the dropped call. Further, the UE may initiate a timer and/or synchronize a connected mode discontinuous reception (CDRX) cycle and/or duration of the first connection for scanning for the potential callback with the transmission schedule of the PS data session, to prevent data collision.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system according to some embodiments;

FIG. 2 illustrates a base station (BS) in communication with a user equipment (UE) device according to some embodiments;

FIG. 3 illustrates an example block diagram of a UE according to some embodiments;

FIG. 4 illustrates an example block diagram of a BS according to some embodiments;

FIG. 5 is a flowchart diagram illustrating a method for utilizing timer activation in a dual subscriber identity module (SIM) dual standby (DSDS) capable UE, according to some embodiments;

FIG. 6 is a flowchart diagram illustrating a method for avoiding spam messaging in a DSDS capable UE, according to some embodiments;

FIG. 7 is a flowchart diagram illustrating a method for handling dropped calls in a DSDS capable UE, according to some embodiments;

FIG. 8 is a flowchart diagram illustrating a method for synchronizing communications in a DSDS capable UE; and

FIG. 9 is a table of call drop cause codes for both 3G and voice over long term evolution (VoLTE) calls, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

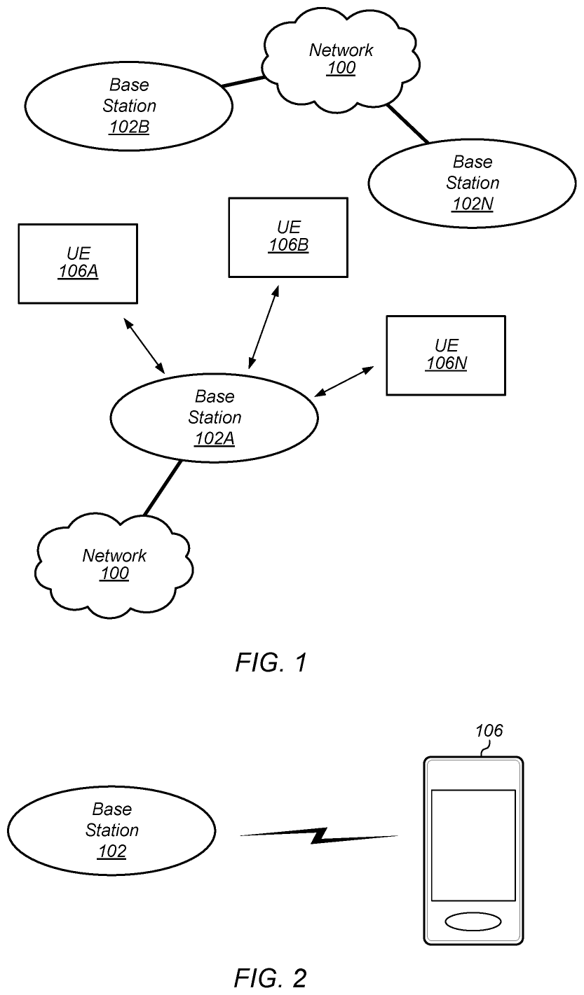

### FIGS. 1 and 2—Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”), and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a wide geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a wearable device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In one embodiment, the UE 106 may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE and 1xRTT (or LTE and GSM), and separate radios for communicating using each of Wi-Fi and Bluetooth. Other configurations are also possible.

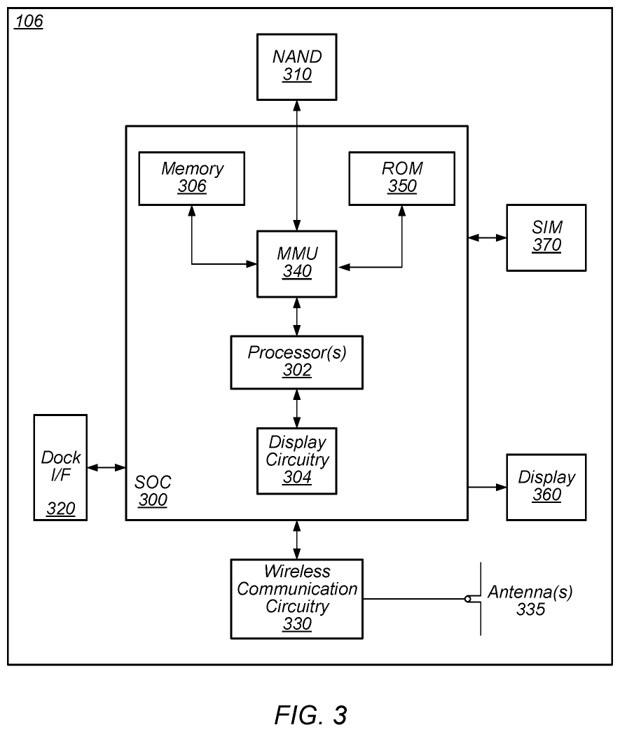

### FIG. 3—Block Diagram of a UE

FIG. 3 illustrates an example block diagram of a UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, CDMA2000, Bluetooth, Wi-Fi, GPS, etc.).

As noted above, the UE 106 may be configured to communicate wirelessly using multiple wireless communication technologies. As further noted above, in such instances, the wireless communication circuitry 330 may include radio components which are shared between multiple wireless communication technologies and/or radio components which are configured exclusively for use according to a single wireless communication technology. As shown, the UE 106 may include at least one antenna (and possibly multiple antennas, e.g., for MIMO and/or for implementing different wireless communication technologies, among various possibilities), for performing wireless communication with cellular base stations and/or other devices. For example, the UE device 106 may use antenna(s) 335 to perform the wireless communication.

The UE 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

As shown, the UE 106 may also include or be coupled to a SIM (Subscriber Identity Module) 370. The SIM 370 may be implemented as an application on a smart card, in some embodiments. The smart card may itself be referred to as a SIM card in some cases. As one example, the SIM 370 may be an application which executes on a Universal Integrated Circuit Card (UICC). The smart card may also include (e.g., store and/or execute) one or more other applications, if desired. The smart card may be removable.

Alternatively, the SIM 370 may be implemented as an embedded SIM (eSIM). In this case, the SIM 370 may be implemented in device hardware and/or software. For example, in some embodiments, the UE 106 may include an embedded UICC (eUICC), e.g., a device which is built into the UE 106 and is not removable. The eUICC may be programmable, such that an eSIM may be implemented on the eUICC. In other embodiments, the eSIM may be installed in UE 106 software, e.g., as program instructions stored on a memory medium (such as memory 306 or NAND 310) executing on a processor (such as processor 302) in the UE 106.

In some embodiments, the UE 106 may be a multi-SIM device, or may at least be multi-SIM capable. Each SIM of such a UE 106 may be implemented in any of various ways, including as a removable SIM or as an embedded SIM, among various possibilities. Dual SIM dual standby (DSDS) and dual SIM dual active (DSDA) are two examples of possible multi-SIM configurations which may be implemented by a UE 106, according to various embodiments.

The subscriber identity information may be used to identify the UE 106 to its subscriber's carrier cellular network. The subscriber identity may also be used outside of the “home” area in which the subscriber's carrier provides cellular service in some situations, for example if the subscriber's carrier has arranged any roaming agreements with other network operators so that the visited network will recognize the subscriber identity information and allow access to the network.

Note that the area in which a subscriber identity may be used to obtain cellular service via the carrier with which the subscriber identity is associated may be considered a “local service area” for the subscriber identity, in which locations the subscriber identity may be considered “local”. In other words, as used herein, a UE 106 may be considered able to obtain “local service” in a location using a subscriber identity if the carrier associated with (e.g., which provided) the subscriber identity provides cellular service in that location.

Any areas in which the subscriber identity may be used to obtain cellular service via another carrier than that with which the subscriber identity is associated (e.g., via one or more roaming agreements) may be considered a “roaming service area” for the subscriber identity. In other words, as used herein, a UE 106 may be considered able to obtain “roaming service” in a location using a subscriber identity if carrier with which a roaming agreement has been negotiated by the carrier associated with the subscriber identity provides cellular service in that location.

Any areas in which the subscriber identity may not be used to obtain cellular service via the carrier with which the subscriber identity is associated or any other may be considered a “no service area” for the subscriber identity. In other words, as used herein, a UE 106 may be considered able to obtain “no service” in a location using a subscriber identity if neither the carrier associated with the subscriber identity nor any other carrier with which a roaming agreement has been negotiated by the carrier associated with the subscriber identity provides cellular service in that location. Note that cellular service may still be available (for example using a different subscriber identity associated with a local carrier) in locations for which no service is available using a particular subscriber identity, though it is also possible that no cellular service may be available at all in some (e.g., remote) locations.

As described herein, the UE 106 may include hardware and software components for implementing part or all of the methods described herein. The processor 302 of the UE device 106 may be configured to implement part or all of the methods described herein, e.g., by executing program instructions stored on a memory medium (e.g., a non-transitory computer-readable memory medium). In other embodiments, processor 302 may be configured as a programmable hardware element, such as an FPGA (Field Programmable Gate Array), or as an ASIC (Application Specific Integrated Circuit). Alternatively (or in addition) the processor 302 of the UE device 106, in conjunction with one or more of the other components 300, 304, 306, 310, 320, 330, 335, 340, 350, 360 may be configured to implement part or all of the features described herein.

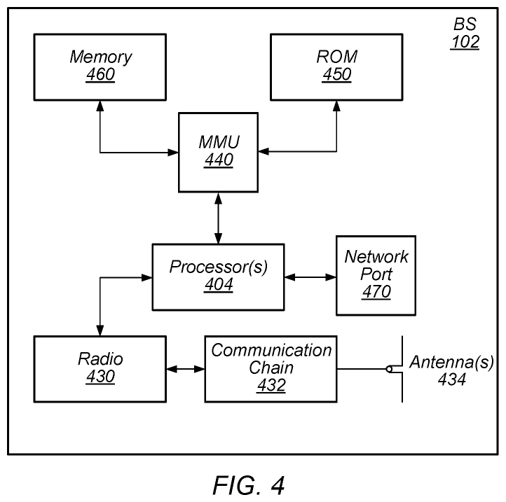

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be configured to communicate via various wireless communication standards, including, but not limited to, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a Wi-Fi radio for performing communication according to Wi-Fi. In such a case, the base station 102 may be capable of operating as both an LTE base station and a Wi-Fi access point. As another possibility, the base station 102 may include a multi-mode radio which is capable of performing communications according to any of multiple wireless communication technologies (e.g., LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

### Dual SIM Dual Standby (DSDS) Capable UEs

As previously noted, in some scenarios a wireless device may be capable of utilizing multiple subscriber identity modules (SIMs). For example, dual SIM support may enable a device to be simultaneously registered with two SIMs, potentially on two different networks. Dual SIM support may include dual SIM dual standby (DSDS) support, in which a device may be simultaneously registered with two SIMs but may actively communicate with one of the networks at a time (e.g., using a shared radio), or dual SIM dual active (DSDA) support, in which a device may be simultaneously registered with two SIMs and may simultaneously actively communicate with two networks at a time, among various dual SIM configurations.

Dual SIM support may be implemented in any of various ways, as desired. For example, a wireless device may provide dual SIM functionality only when the device is in a roaming state (e.g., with respect to a particular SIM such as a primary SIM of the wireless device, or possibly with respect to all SIMs of the device), or only when the device is registered with a home network, or both when the device is roaming and when the device is registered with a home network, among various possibilities. As another example, when dual SIM functionality is implemented different SIMs may have different availabilities with respect to voice and data communication. Thus as one possibility, a primary SIM (e.g., associated with a first subscription) might be made available for voice communication, while a secondary SIM (e.g., associated with a second subscription) might be made available for data communication. Alternate arrangements (e.g., primary SIM available for data, secondary SIM available for voice; both primary and secondary SIMs available for both voice and data; both primary and secondary SIMs available for voice only or for data only, etc.) are also possible. As a still further example, when dual SIM functionality is implemented, different SIMs may have different availabilities with respect to different radio access technologies (RATs); for example, one or more RATs available to one SIM might not be available to the other SIM (and/or vice versa), and/or one or both SIMs might have different RAT availability depending on whether the wireless device is operating in a dual SIM mode or a single SIM mode. As one possible configuration, a SIM might be configured to use any of GSM, WCDMA, and/or LTE for voice and/or data communications when operating in a single SIM mode, and might be configured with the same capabilities or only a subset of those capabilities (e.g., voice only and GSM only, as one possibility) when operating in a dual SIM mode. Numerous other configurations are also possible and should be considered within the scope of this disclosure.

Note also that in some instances, the specific configuration of a dual SIM capable wireless device at a particular time may result from any combination of hardware and/or software features of the wireless device, subscription characteristics of the SIMs used with the wireless device, and/or user preference(s), among various possible considerations and/or constraints.

In some scenarios, it may be the case that a SIM provides packet switched services in one mode of operation and not in another. For example, as one possibility, a wireless device might be configured to use a dual SIM mode when a primary SIM of the device is in a roaming state. In order to avoid data roaming charges with the primary SIM (and/or for any of various other possible reasons), a secondary SIM with a local data plan may be used in the dual SIM mode to provide packet switched (data) services, and the primary SIM may be used in the dual SIM mode to provide circuit switched (voice) services. In such a scenario, packet switched services may not be available using the primary SIM when in dual SIM mode, and so the wireless device may not be able to access a packet switched data network of a carrier (e.g., cellular service provider) associated with the primary SIM.

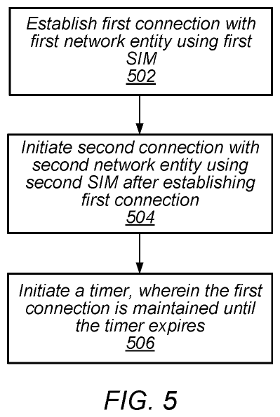

If the wireless device wishes to perform a data operation (e.g., send or retrieve a multimedia messaging service (MMS) message, retrieve a visual voicemail (VVM) message, or perform any of various other subscription specific operations) with the carrier network of the primary SIM when in such a dual SIM mode, this may present a difficulty. FIGS. 5-8 are flowchart diagrams illustrating example methods that may be performed by a multi-SIM capable UE to improve performance in these or other scenarios.

### Timer Activation for Maintaining Connection in DSDS UEs

In DSDS devices, when one of the subscriptions (e.g., subscription 2, or “sub-2” associated with SIM 2) is doing high priority signaling activity, the other subscriber (e.g., subscription 1, or “sub-1” associated with SIM 1) may be suspended and may be unable to conduct transmission (TX) or reception (RX) activities. In some current implementations, when sub-1 is suspended, the radio resource control (RRC) connection may be released immediately. When sub-1 receives the RF-chains back (e.g., when sub-2 have finished its high priority signaling activity), a fresh cell selection procedure may be triggered. If there is pending data to be sent, a new RRC Connection may be setup. Accordingly, the UE may experience battery drain and/or increased latency as a result of the cell selection procedure and/or RRC connection setup procedure (e.g., including security establishment, data radio bearer (DRB) configuration, etc.)

To address these and other concerns, embodiments herein present methods and devices for utilizing timer activation to improve DSDS functionality. In some embodiments, in the scenario described above, when sub-1 is suspended, a short timer may be initiated for a predetermined number of seconds. and the RRC Connection may not be released while the timer is running. Upon expiration of the timer, the UE may determine whether the RF chains have been received back from sub-2.

If the RF chains have not been received back by sub-1 from sub-2 upon expiry of the timer, the UE may release the RRC connection associated with sub-1. If the RF chains have been received back by sub-1 from sub-2 upon expiry of the timer, the UE may determine whether there is pending data to be sent via sub-1. If there is pending data to be sent, the UE may send a valid scheduling request (SR) to the network to send the pending data. If it is determined that there is not any pending data to be sent via sub-1 when the RF chains are received back from sub-2, the UE may send a dummy SR or connection re-establishment request to the network, to maintain the connection associated with sub-1. The dummy request may help to check if the network still has the UE context.

In some embodiments, if the network (NW) responds back to the SR (regardless of whether the SR is a valid SR), the UE may continue with the current RRC Connection via sub-1. On the other hand, if the network fails to respond to the SR, the UE may infer that the network has abandoned the sub-1 connection and may release the RRC connection on the UE side.

The dummy SR may operate according to a simple request and response procedure, to check if the NW has the UE context or not. In some embodiments, the UE may not use the exact SR configuration as indicated by the NW in the over-the-air (OTA) RRC Reconfiguration message. Instead, it may use a lower threshold value so that power expenditure incurred through the dummy SR procedure is reduced. In some embodiments, the lower threshold value may be configurable, based on one or more of user preference, current remaining battery life of the UE, or network preferences, among other possibilities.

In some embodiments, the dummy SR procedure described herein may be extended for utilization during packet switched (PS) and/or circuit switched (CS) signaling on the other subscription (e.g., sub-2), internet protocol multimedia subsystem (IMS) signaling on the other subscription, and or short data transfer procedures on a non-dedicated data subscription (non-DDS).

### Timer Activation for Handling Spam Messaging in DSDS

Spam messages (e.g., unsolicited short message service (SMS) messages, multimedia messaging service (MMS) messages, or other unsolicited text or multimedia messages) are quite common in current wireless communication environments, and are particularly common in Indian and Chinese cellular markets. In DSDS devices, when a data session is ongoing through a packet switched (PS) preferred subscription (e.g., sub-2 as described above) and a spam SMS is received on a non-PS preferred subscription (e.g., sub-1 as described above) then a data stall may be observed on the PS preferred subscription since the non-PS preferred subscription may keep the RRC connection (e.g., to receive multiple messages in the same RRC connection irrespective of whether they are spam) until the NW releases the connection due to data inactivity. Accordingly, the PS preferred subscription may experience a data stall ranging from 15 seconds to as long as 1 minute, for example, leading to a poor user experience.

To address these and other concerns, some embodiments herein present methods and devices for utilizing timer activation for reducing the adverse impact of spam messaging in DSDS devices. In some embodiments, when a SMS/MMS text is received on the non-PS preferred subscription, the UE may implement the following procedure.

First, the UE may query an application processor of the UE to check whether the message being received is spam or not. If it is a spam message, the UE may implement the following changes to the data inactivity timer, depending on whether the PS preferred subscription is in an idle state or is conducting an active data transfer.

If the PS preferred subscription is in an idle state and is not currently conducting an active data transfer, the UE may initiate the inactivity timer for a short duration (e.g., approximately 2 seconds or another short duration). On the other hand, if the PS preferred subscription is conducting an active data transfer procedure, the UE may not run the inactivity timer at all, or it may run the inactivity timer with a null duration of zero seconds.

After initiating the inactivity timer with either a short or a null duration, upon timer expiry the UE may release the RRC connection, enter an RRC idle state, and relinquish the RF resources of the UE to the PS preferred subscription.

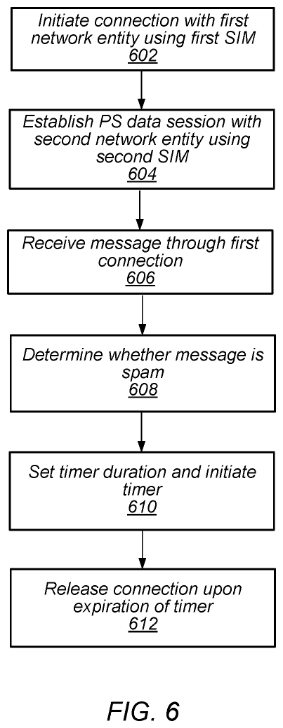

### FIGS. 5-6—Flowcharts for Timer Activation in DSDS Devices

FIGS. 5-6 are flowchart diagrams illustrating two methods for utilizing timer activation to improve the functionality of a DSDS device, according to some embodiments. The methods shown in FIGS. 5-6 may be used in conjunction with any of the computer systems or devices shown in the above Figures, among other devices. For example, the methods shown in FIGS. 5-6 may be used by a UE configured to operate in a dual SIM mode. In the dual SIM mode, packet switched (PS) services may not be available or preferred using a first SIM of the UE. For example, the UE may be a wireless device that operates in dual SIM mode with the first SIM available for voice services and a second SIM available for data services when the first SIM is roaming, such as previously described. Any number of alternate scenarios in which PS services are not available using the first SIM, such as if the first SIM is out-of-service at a particular time, are also possible. The UE may be configured for dual subscriber identity module (SIM) dual standby (DSDS) operation. In some embodiments, the DSDS operation may utilize a first SIM that is not capable of packet switched (PS) services and a second SIM that is capable of PS services. Alternatively, the DSDS operation may utilize a first SIM and a second SIM that are both capable of PS services, but the first SIM may be configured as not preferred for PS services, and the second SIM may be configured as preferred for PS services. More specifically, FIG. 5 illustrates a method whereby a DSDS capable UE utilizes a timer in connection with a sequential initiation of a first RRC connection using a first SIM and a subsequent second connection using a second SIM. This method may be used in various types of cellular communication systems across any of a variety of cellular technologies. In various embodiments, some of the elements of the scheme shown may be performed concurrently, in a different order than shown, or may be omitted. Additional and/or alternative elements may also be performed as desired. As shown, the method of FIG. 5 may operate as follows.

In 502, a first connection may be established with a first network entity using the first SIM. The first connection may be a radio resource control (RRC) connection, or it may be another type of connection. In some embodiments, the RRC connection may support short messaging or packet switched data services.

In 504, a second connection may be initiated with a second network entity using the second SIM after establishing the first connection. The second connection may be a high priority data session carrying data such as signaling data or short messaging data, and initiating the second connection by the second SIM may suspend access to one or more radio frequency chains of the UE by the first SIM.

In 506, a timer may be initiated at least in part in response to initiating the second connection using the second SIM. The first connection may be maintained until the timer expires.

In some embodiments, upon expiration of the timer, it may be determined whether the second SIM has returned access to one or more radio frequency (RF) chains of the UE to the first SIM. Based on a determination that the second SIM has not returned access to the one or more RF chains of the UE to the first SIM upon expiration of the timer, the first connection with the first network entity may be released. Alternatively, based on a determination that the second SIM has returned access to the one or more RF chains of the UE to the first SIM upon expiration of the timer, a scheduling request message may be sent to the first network entity through the first connection using the one or more RF chains.

In some embodiments, it may be determined whether pending data is waiting to be sent on the first connection when the timer expires. In these embodiments, if it is determined that pending data is not waiting to be sent on the first connection, the scheduling request message may be a dummy scheduling request message. For example, the dummy scheduling request message may be used to keep the first connection alive, even though the pending data is not currently waiting to be sent on the first connection, to prevent the UE from having to expend energy in reestablishing the first connection.

FIG. 6 is a method flow chart diagram illustrating a method for operating a DSDS capable UE when a spam message is received through a first SIM. This method may be used in various types of cellular communication systems across any of a variety of cellular technologies. In various embodiments, some of the elements of the scheme shown may be performed concurrently, in a different order than shown, or may be omitted. Additional and/or alternative elements may also be performed as desired. As shown, the method of FIG. 6 may operate as follows.

At 602, a connection may be initiated with a first network entity using a first SIM of the UE. The connection may be a PS connection, or a CS connection. Messages such as short message service (SMS) messages or other text, voice, and/or video messaging may be received on the connection.

At 604, a PS data session may be established with a second network entity using a second SIM of the UE.

At 606, a message may be received through the first connection using the first SIM.

At 608, it may be determined, by accessing an application processor of the UE, whether the message is a spam message. For example, an application processor of the UE may be configured to identify types of messages or message characteristics that are associated with spam messaging.

At 610, a timer duration may be set based on a determination that the message is a spam message, and the timer may be initiated at least in part in response to receiving the message through the connection using the first SIM. The connection may be maintained until the timer expires.

At 612, the connection may be released upon expiration of the timer.

In some embodiments, if it is determined that the message is a spam message, the UE may determine whether a data transfer is currently taking place over the PS data session (i.e., the data session associated with the second SIM). If it is determined that a data transfer is currently taking place, the timer initiated at step 610 may be set to a shorter duration than when it is determined that a data transfer is not currently taking place on the PS data session. In some embodiments, based on a determination that the data transfer is currently taking place over the PS data session, the timer duration may be set to zero seconds. On the other hand, if an active data transfer is not currently taking place, the timer duration may be set to a predetermined number of seconds (e.g., 2, 3, or 5 seconds). In these embodiments, the first connection may be released upon expiration of the timer, to avoid subsequent spam messages that may interfere with the ongoing data transfer. In some embodiments, releasing the first connection may involve entering a radio resource control (RRC) idle state for the first connection and handing over access to one or more radio frequency chains of the UE to the second SIM.

Note that while the SIMs of the UE may be distinguished herein by the use of the terms “first” and “second” for the sake of clarity, it should be noted that this is not intended to imply any ordinal relation between the SIMs such as whether a SIM is a primary SIM or a secondary SIM, or to imply that a primary/secondary relationship exists between the SIMs at all; the “first SIM” may be either a primary SIM or a secondary SIM, while the “second SIM” may likewise be either a primary or secondary SIM, or the SIMs may be considered peers, among various possible embodiments.

### Handling Dropped Calls in DSDS Devices

In Dual-SIM scenarios such as occur in DSDS devices, a situation may occur whereby a first SIM of a UE device answers a voice call (e.g., a circuit switched (CS) call or VoLTE call), but the call is inadvertently dropped due to a network error or other type of error. In a DSDS device, terminating a call on a first SIM may automatically trigger the UE to release the RRC connection associated with the first SIM, and perform a handover of RF resources to a second SIM of the UE device, for performing a camping procedure and/or initiating a data transfer or other network operation. However, in this scenario, while the UE may have released the RRC connection, the network may not yet be notified and may still consider the UE to be in an RRC connected state. This RRC-mismatch between the presumed connection status at the UE side and the network side may result in an undesirable expenditure of resources by the network, which may attempt to communicate with the UE even though the UE may not be listening. For example, after the call drop, if the UE receives a subsequent mobile terminated call through the first SIM, the network may send a call paging message via dedicated channels, as it still assumes the UE is in a connected state.

Additionally, if the call drop was unintentional, the UE may likely receive a callback from the originator of the dropped call shortly after the call is dropped. If RF resources have already been handed over to the second SIM when the callback is received, the UE may not be able to receive the callback, resulting in a poor user experience.

To address these and other concerns, some embodiments herein describe methods and devices for employing timers and synchronization techniques to improve performance of a non-data preferred subscription for both PS and CS services in a DSDS device.

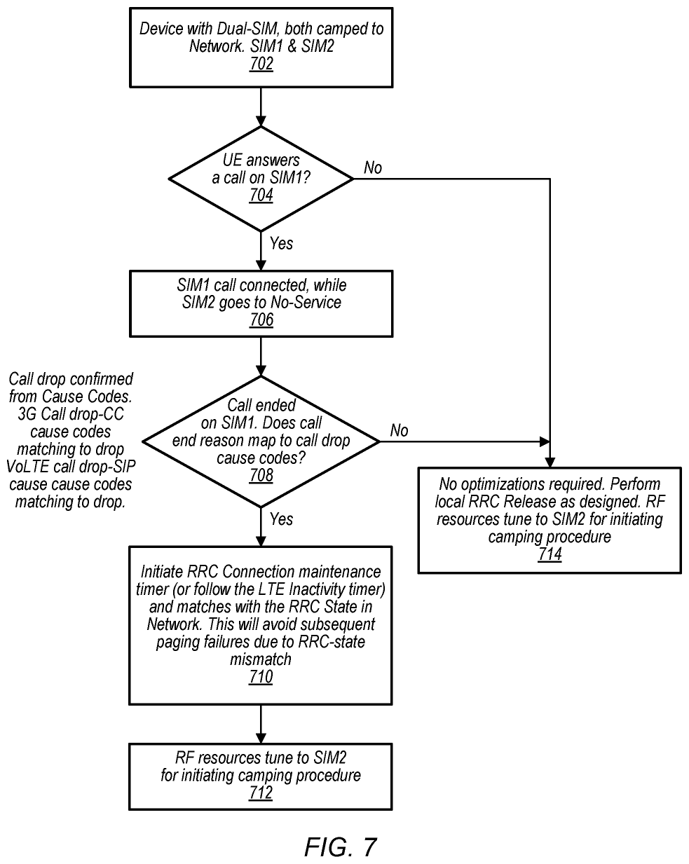

### FIG. 7—Flowchart for Handling Call Drop in DSDS Device

FIG. 7 is a flowchart diagram illustrating an exemplary method for handling a call drop in a DSDS device, according to some embodiments. The method shown in FIG. 7 may be used in conjunction with any of the computer systems or devices shown in the above Figures, among other devices. For example, the method shown in FIG. 7 may be used by a UE configured to operate in a dual SIM mode. In the dual SIM mode, packet switched (PS) services may not be available using a first SIM of the UE. For example, the UE may be a wireless device that operates in dual SIM mode with the first SIM available for voice services and a second SIM available for data services when the first SIM is roaming, such as previously described. Any number of alternate scenarios in which PS services are not available using the first SIM, such as if the first SIM is out-of-service at a particular time, are also possible. The UE may be configured for dual subscriber identity module (SIM) dual standby (DSDS) operation, wherein the DSDS operation utilizes a first SIM that is not capable of packet switched (PS) services and a second SIM that is capable of PS services. This method may be used in various types of cellular communication systems across any of a variety of cellular technologies. In various embodiments, some of the elements of the scheme shown may be performed concurrently, in a different order than shown, or may be omitted. Additional and/or alternative elements may also be performed as desired. As shown, the method of FIG. 7 may operate as follows.

At 702, a DSDS UE device may camp on a separate network through each of two SIM cards. For example, the UE may establish a first connection with a first network entity using the first SIM and may establish a second connection with a second network entity using the second SIM. The subscription of the first SIM may be capable or incapable of performing PS data transfer procedures, but may in any case not be preferred for conducting PS services, and may be considered the non-PS preferred subscription. The second SIM may be capable of performing PS data procedures, and may be associated with a PS preferred subscription which the UE may preferentially utilize for PS data transfer procedures.

At 704, the UE may receive a call on the first SIM, which may be a CS call or a PS call such as a VoLTE call. If the UE does not answer the incoming call, the UE may proceed to step 714 and operate normally. For example, the UE may perform a local RRC connection release to handover the RF resources to the second SIM for initiating a camping procedure for an upcoming data procedure.

If the UE does answer the call, the UE may proceed to step 706, the call may be connected through the first SIM, and the second SIM may enter a no-service state.

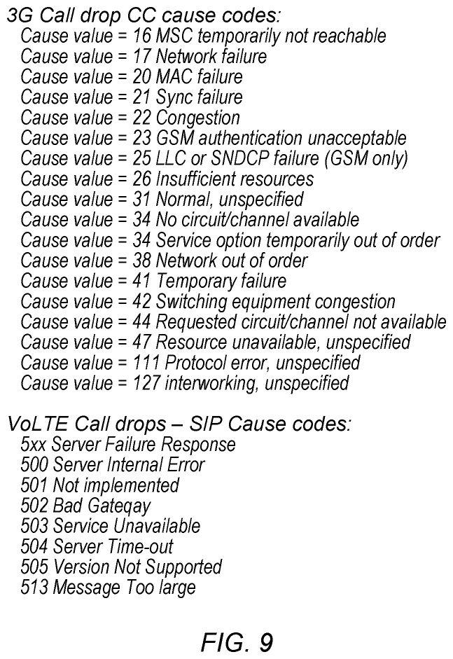

At 708, the ongoing call may be ended on the first SIM. In response to the call ending, the UE may determine whether the call ended intentionally or because of an inadvertent call drop. For example, the UE may consult an application processor of the UE to determine whether a call drop code associated with the call drop matches a call drop cause code in a list of call drop cause codes known to the application processor. For example, FIG. 9 lists a variety of call drop cause codes that are associated with different reasons for a call dropping, in both 3G calls and VoLTE calls.

If it is determined that the call drop code does not correspond to a call drop cause code in the list of call drop cause codes, the UE may infer that the call drop was intentional and may proceed to step 714 to release the local RRC connection over the first SIM and handover the RF resources to the second SIM for initiating a camping procedure.

On the other hand, if the call drop code does correspond to a call drop cause code in the list of call drop cause codes, the UE may proceed to step 710 and may implement one of various methods to increase the likelihood of the UE successfully receiving a potential callback over the first connection subsequent to the call drop.

In some embodiments, at least in part in response to determining that the voice call has been dropped, an RRC connection maintenance timer associated with the first connection may be initiated. The first connection may be maintained until expiration of the RRC connection maintenance timer. In some embodiments, the first connection may be maintained in connected state until expiration of the RRC connection maintenance timer so that the UE remains in sync with the network and can, for example, receive a paging message that the network may send via dedicated channels indicating a callback a shortly after a call drop.

In some embodiments, the UE may request from the network to maintain the RRC connection associated with the first SIM for a small period of time, during which the first connection may enter an RRC idle state and the PS-preferred subscription may perform out-of-service (OOS) scans and recover back service. In some embodiments, if the dropped call is a VoLTE call, the UE may redirect the first SIM to a CS radio access technology (RAT), e.g., if the current LTE link is relatively poor for voice call sustainability.

In some embodiments, the NW may not accede to the UE's request to either maintain the RRC connection of the first SIM for the timer duration, to redirect to a CS RAT, or to change the CDRX cycle and/or duration. In these embodiments, the UE may immediately release the connection of the non-PS preferred subscription locally after the voice call ends and may perform OOS scans on the PS-preferred subscription. The UE may then quickly return back to non-PS preferred subscription to monitor pages and initiate a dummy RRC connection with the NW to remain in sync.

If the voice call fails with a particular code known to be associated with a call drop cause, the UE may adaptively increase the data inactivity timer on the non-PS preferred SIM, and may then initiate a connection release procedure upon expiration of the extended data inactivity timer. For example, the UE may set a timer duration in the range of two to eight seconds, such that the connection is maintained long enough to likely receive a callback, should one occur.

In some embodiments, if the connection was released locally (e.g., if the call drop was intentional), the UE may do a tracking area update (TAU) procedure on the non-PS preferred SIM and then relinquish the RF resources to the PS preferred subscription at step 712 so that the non-PS preferred SIM's context is present with the NW.

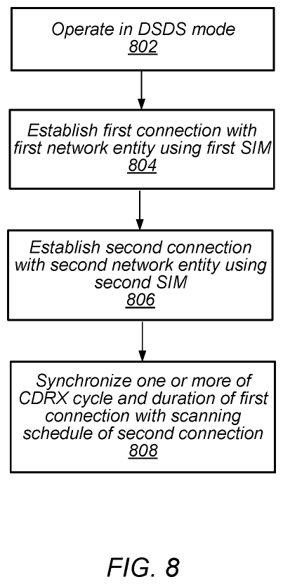

### FIG. 8—DSDS Synchronization Flowchart

FIG. 8 is a flowchart diagram illustrating a method to utilize timing synchronization during DSDS operation.

At 802, the UE may operate in DSDS mode. For example, as described in greater detail above, the UE may have a first SIM and a second SIM, and may be configured to alternate access to RF resources between the two SIMs, whereby at any given time one of the SIMs may have active access to RF resources of the UE, while the other SIM is in a standby mode.

At 804, the UE may establish a first connection with a first network entity using a first SIM. In some embodiments, the first connection may be a connected mode discontinuous reception (CDRX) connection.

At 806, the UE may establish a second connection with a second network entity using a second SIM of the UE. The second connection may be a connection that utilizes a periodic scanning scheduling to scan for paging or other types of signaling from the network.

At 808, the UE may synchronize one or more of a CDRX cycle and duration associated with the first connection with a scanning schedule associated with the second connection. For example, the UE may perform out-of-service (OOS) scans using the second SIM, and the UE may schedule CDRX cycle on durations associated with the first connection in between the OOS scans. In some embodiments, the UE may change the CDRX cycle and duration such to be synchronized with the OOS scans on the PS preferred subscription, and the mobile-terminated page and connection release OTA message may be decodable in the non-PS preferred subscription.

In some embodiments, when both the PS preferred and non-PS preferred subscriptions are performing data transfer procedures, then instead of losing the RRC connection on the non-PS preferred subscription, the UE may maintain the RRC connection on both subscriptions and may initiate the data transfer as follows.

In some embodiments, the UE may transmit a request or requests to the network for a CDRX pattern which is mutually exclusive between both the subscriptions. For example, the UE may request a CDRX pattern that interweaves the transmission associated with the two subscriptions in time, so that they do not collide by simultaneously performing transmission attempts. The PS-preferred subscription may give the RF resources to the non-PS preferred subscription during its CDRX OFF durations so that the non-PS preferred subscription may perform data transfer procedure without experiencing throughput loss.

In some embodiments, if a collision still exists between data transfers for the two subscriptions even after aligning the CDRX patterns, then the UE may determine one of the subscriptions to receive preferential RF resource access. The UE may consider a variety of factors in determining which subscription will receive preferential RF resource access. For example, for the data transfer procedure on each of the two subscriptions, the UE may consider the type of data transfer (e.g., whether it is for high or ow priority data, and/or whether it is associated with a background or foreground application running on the UE), the length of the data transfer procedure, and/or the availability of throughput based on properties of the serving cell and/or secondary cells such as their power levels and/or their radio link control (RLC) or packet data convergence protocol (PDCP) characteristics, among other possibilities.

In some embodiments, the UE may consider a weighted summation of the data transfer type, the data transfer duration, and the throughput availability for each of the two subscriptions when determining which subscription to give preferential access to RF resources. For example, the UE may designate a first variable A to represent the type of data transfer (e.g., with higher priority data transfers and/or data transfers associated with foreground applications receiving a larger value of A), a second variable B to represent the length of the data transfer procedure, and a third variable C to represent the available throughput for the data transfer. The UE may then compute a weighted summation such as 0.5A+0.2B+0.3C for each of the two subscriptions, and preferential access to RF resources may be granted to the subscription with a larger value of the weighted summation. It may be appreciated that the weight factors 0.5, 0.2, and 0.3 are intended for illustrative purposes only, and different weights may also be used, as desired.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1-14. (canceled)

15. A method, comprising:
by a wireless user equipment device (UE):
operating in a dual subscriber identity module (SIM) dual standby (DSDS) mode;
establishing a first connection with a first network entity using [[the]]a first SIM;
establishing a second connection with a second network entity using [[the]]a second SIM;
in response to an incoming voice call from the first network entity, answering the voice call using the first SIM and de-activating the second connection;
determining that the voice call has been dropped;
at least in part in response to determining that the voice call has been dropped, initiating a radio resource control (RRC) connection maintenance timer associated with the first connection; and
maintaining the first connection until expiration of the RRC connection maintenance timer.

16. The method of claim 15, the method further comprising:
reactivating the second connection upon expiration of the RRC connection maintenance timer.

17. The method of claim 15, the method further comprising:
receiving a callback from the first network entity during a CDRX on-duration of the first connection before expiration of the RRC connection maintenance timer.

18. The method of claim 15,
wherein determining that the voice call has been dropped comprising receiving a call drop code from the first network entity,
wherein the voice call comprises one of a circuit switched (CS) call or a voice over long-term evolution (VoLTE) call, and
wherein the call drop code comprises one of:
a 3G call drop code, or
a VoLTE call drop code.

19. The method of claim 15, the method further comprising:
based on a determination that the RRC connection maintenance timer has expired and a callback has not been received via the first connection, dropping the first connection.

20. The method of claim 15, the method further comprising:
synchronizing one or more of a connected mode discontinuous reception (CDRX) cycle and duration associated with the first connection with a scanning schedule associated with the second connection.

21. The method of claim 20,
wherein reactivating the second connection comprises performing out-of-service (OOS) scans using the second SIM, and
wherein synchronizing one or more of the CDRX cycle and duration with the scanning schedule comprises scheduling CDRX cycle on durations associated with the first connection in between the OOS scans.

22. The method of claim 21, the method further comprising:
determining that synchronizing one or more of the CDRX cycle and duration with the scanning schedule is unsuccessful;
based on determining that synchronizing one or more of the CDRX cycle and duration with the scanning schedule is unsuccessful, prioritizing data transfer associated with either the first SIM or second SIM based on one or more of:
a relative priority of the data transfers associated with the first and second SIMs;
whether the data transfers associated with the first and second SIMs are associated with foreground or background applications running on the UE;
an available throughput associated with the first and second connections; and
a length of a data transfer procedure associated with each of the first and second SIMs.

23. A wireless user equipment device (UE), comprising:
a radio;
one or more processors operably coupled to the radio;
wherein the radio and the one or more processors are configured to:
operate in a dual subscriber identity module (SIM) dual standby (DSDS) mode;
establish a first connection with a first network entity using a first SIM of the UE;
establish a second connection with a second network entity using a second SIM of the UE;
in response to an incoming voice call from the first network entity, answer the voice call using the first SIM and de-activating the second connection;
determine that the voice call has been dropped;
at least in part in response to determining that the voice call has been dropped, initiate a radio resource control (RRC) connection maintenance timer associated with the first connection; and
maintain the first connection until expiration of the RRC connection maintenance timer.

24. The UE of claim 23, wherein the radio and the one or more processors are further configured to:
reactivate the second connection upon expiration of the RRC connection maintenance timer.

25. The UE of claim 23, wherein the radio and the one or more processors are further configured to:
receive a callback from the first network entity during a CDRX on-duration of the first connection before expiration of the RRC connection maintenance timer.

26. The UE of claim 23,
wherein in determining that the voice call has been dropped, the UE is configured to receive a call drop code from the first network entity,
wherein the voice call comprises one of a circuit switched (CS) call or a voice over long-term evolution (VoLTE) call, and
wherein the call drop code comprises one of:
a 3G call drop code, or
a VoLTE call drop code.

27. The UE of claim 23, wherein the radio and the one or more processors are further configured to:
based on a determination that the RRC connection maintenance timer has expired and a callback has not been received via the first connection, drop the first connection.

28. The UE of claim 23, wherein the radio and the one or more processors are further configured to:
synchronize one or more of a connected mode discontinuous reception (CDRX) cycle and duration associated with the first connection with a scanning schedule associated with the second connection.

29. The UE of claim 28,
wherein in reactivating the second connection, the UE is configured to perform out-of-service (OOS) scans using the second SIM, and
wherein in synchronizing one or more of the CDRX cycle and duration with the scanning schedule, the UE is configured to schedule CDRX cycle on durations associated with the first connection in between the OOS scans.

30. The UE of claim 29, wherein the radio and the one or more processors are further configured to:
determine that synchronizing one or more of the CDRX cycle and duration with the scanning schedule is unsuccessful;
based on determining that synchronizing one or more of the CDRX cycle and duration with the scanning schedule is unsuccessful, prioritize data transfer associated with either the first SIM or second SIM based on one or more of:
a relative priority of the data transfers associated with the first and second SIMs;
whether the data transfers associated with the first and second SIMs are associated with foreground or background applications running on the UE;
an available throughput associated with the first and second connections; and
a length of a data transfer procedure associated with each of the first and second SIMs.

31. A non-transitory computer accessible memory medium comprising program instructions for a wireless user equipment (UE) that, when executed by a processor of the UE, cause the UE to:
operate in a dual subscriber identity module (SIM) dual standby (DSDS) mode;
establish a first connection with a first network entity using a first SIM of the UE;
establish a second connection with a second network entity using a second SIM of the UE;
in response to an incoming voice call from the first network entity, answer the voice call using the first SIM and de-activating the second connection;
determine that the voice call has been dropped;
at least in part in response to determining that the voice call has been dropped, initiate a radio resource control (RRC) connection maintenance timer associated with the first connection; and
maintain the first connection until expiration of the RRC connection maintenance timer.

32. The non-transitory computer accessible memory medium of claim 23, wherein the program instructions are further executable to cause the UE to:
reactivate the second connection upon expiration of the RRC connection maintenance timer.

33. The non-transitory computer accessible memory medium of claim 23, wherein the program instructions are further executable to cause the UE to:
receive a callback from the first network entity during a CDRX on-duration of the first connection before expiration of the RRC connection maintenance timer.

34. The non-transitory computer accessible memory medium of claim 23,
wherein in determining that the voice call has been dropped, the program instructions are further executable to cause the UE to receive a call drop code from the first network entity,
wherein the voice call comprises one of a circuit switched (CS) call or a voice over long-term evolution (VoLTE) call, and
wherein the call drop code comprises one of:
a 3G call drop code, or
a VoLTE call drop code.
